(19) United States
(12) Patent Application Publication
(10) Pub. No.: US 2012/0047813 A1
(43) Pub. Date: Mar. 1, 2012

(54) CUTTING FLUID FOR WAFER PROCESSING

(75) Inventors: HENG-KWONG TSAO, TAOYUAN COUNTY (TW); CHIA-NAN YUAN, KEELUNG CITY (TW)

(73) Assignee: NATIONAL CENTRAL UNIVERSITY, JHONGLI CITY, TAOYUAN COUNTY (TW)

(21) Appl. No.: 12/948,039

(22) Filed: Nov. 17, 2010

(30) Foreign Application Priority Data
Aug. 25, 2010 (TW) 099128403

(51) Int. Cl. C09K 3/14

(52) U.S. Cl. 51/309; 51/293; 51/307

(57) ABSTRACT

A cutting fluid for processing is revealed. The cutting fluid for wafer processing includes a cutting solvent, a plurality of cutting particles and a surfactant that induces hydrogen bonding. The surfactant that induces hydrogen bonding contains amine functional groups or acid functional groups. The hydrogen-bonding-inducing surfactant is used to form intermolecular hydrogen bonding so as to improve the suspension stability of the cutting particles in the cutting fluid. The surfactant that induces hydrogen bonding will not change the properties of the cutting fluid so that the following processes will not be affected.

### BACKGROUND OF THE INVENTION

1. Fields of the invention

The present invention relates to a cutting fluid for wafer processing, especially to a cutting fluid added with a surfactant that induces hydrogen bonding and improves suspension stability of a plurality of cutting particles.

2. Descriptions of Related Art

Due to global energy shortage, development of secure alternative energy supply that can be regenerated and consumed without pollution is a top priority. Among the alternative energy sources, solar cell technology has attracted significant attention. Along with the progress of the day, prosperous economy, the booming industry, and people's requirements of high quality lives, energy plays an increasingly important role in our daily lives. The supply of mineral energy resources falls short of demand due to the tremendous energy consumption. Under over development and utilization of energy resources, the price of the limited energy has increased rapidly. All energy sources will be exhausted.

The manufacturing of solar cells needs wafers. The wafer manufacturing processes used now includes a plurality of steps in turn such as crystal growth, slicing, lapping, polishing, cleaning, etc. Among them, the ingot slicing plays an important role in quality and cost control within the whole wafer fabrication processes. The wafers are cut mainly by wire cut machines. The steel wire itself is unable to cut ingots. Thus the steel wire is wetted with a cutting fluid so as to bring the cutting fluid cutting through the ingot while cutting ingots. The cutting fluid contains a plurality of cutting particles that slices ingots into wafers. Besides cutting the ingots, the cutting fluid is also used to remove heat and chips generated during the cutting process for improving the cutting efficiency. The cutting fluid used now includes a plurality of cutting particles with larger diameter and high density. Yet these cutting particles are unable to be suspended in the cutting fluid stably and this has influence on the cutting efficiency.

In order to increase the suspension stability of the cutting particles, polymers or polyelectrolytes are added into the cutting fluid. The viscosity of the cutting fluid is increased dramatically when polymers are added into the cutting fluid. The sedimentation velocity of the cutting particles in the cutting fluid is in inverse proportion/relation to the fluid viscosity so that the sedimentation velocity of the cutting particles in the cutting fluid declines with increasing viscosity. Thus the cutting particles are suspended in the fluid stably for a longer time. However, the addition of polymers has limited effect on the improvement of the sediment velocity of the cutting particles. The particle sedimentation still occurs and the above problems haven't been solved yet.

Moreover, the increasing fluid viscosity caused by addition of polymers has great influence on the wafer fabrication processes after cutting. For example, the wafer separation or cleaning may be getting more difficult due to increased viscosity of the cutting fluid.

When polyelectrolytes are added into the cutting fluid, the cutting particles have stronger Coulombic interaction due to ion absorption on the cutting particles. Thus the cutting particles are repelling one another, not aggregated and suspended well. Most of the cutting particles are silicon carbide particles that have larger diameter and higher density. Thus the gravity of the cutting particles will lead to sedimentation even they don't aggregate and settle. However, the addition of electrolytes has limited effect. The addition of the electrolytes will cause the cutting solution to have a large amount of charges and its effect on the stability of wafers still remains unclear.

In order to solve the above problems, there is a need to provide a cutting fluid for wafer processing that induces hydrogen bonding, increases the suspension time of the cutting particles dramatically, and improves suspension stability of the cutting particles.

### SUMMARY OF THE INVENTION

Therefore it is a primary object of the present invention to provide a cutting fluid for wafer processing in which a surfactant that induces hydrogen bonding is added. The surfactant that induces hydrogen bonding contains amine functional groups or acid functional groups. Hydrophilic groups of the hydrogen-bonding-inducing surfactant are capable to form intermolecular hydrogen bonding so that the cutting particles have three-dimensional network structure. Thus the suspension time of the cutting particles is significantly increased and the suspension stability of the cutting particles is effectively improved.

In order to achieve above object, the cutting fluid for wafer processing consists of a cutting solvent, a plurality of cutting particles added in the cutting solvent and a surfactant that induces hydrogen bonding added into the cutting fluid. A plurality of molecules of the hydrogen-bonding-inducing surfactant can form intermolecular hydrogen bonding so as to improve the suspension stability of the cutting particles in the cutting solvent.

### DETAILED DESCRIPTION OF THE PREFERRED EMBODIMENT

The semiconductor wafer manufacturing processes includes a plurality of steps in turn such as crystal growth, slicing, lapping, polishing, cleaning, etc. The ingot slicing plays an important role in quality and cost control within the wafer manufacturing processes. Now wafers are cut mainly by wire cut machines. While cutting ingots, a steel wire is wetted with a cutting fluid. The steel wire itself is unable to cut ingots and it's used to bring the cutting fluid cutting through the ingot. By means of a plurality of cutting particles, the cutting fluid slices ingots into wafers. Besides cutting the ingots, the cutting fluid is also used for removal of the heat generated during the cutting process and removal of chips for improving the cutting efficiency. The cutting fluid available now includes a plurality of cutting particles with larger diameter and high density. However, these cutting particles are unable to be suspended in the cutting fluid stably and this has negative effect on the cutting efficiency.

In order to solve the above problems, a cutting fluid for processing of semiconductor wafers of the present invention is provided. The cutting fluid includes a cutting solvent, a plurality of cutting particles and a surfactant that induces hydrogen bonding. The cutting solvent can be water or alcohols. The alcohol can be ethylene glycol or propylene glycol while ethylene glycol is preferred. The cutting particle is made from one of the following materials: silicon carbide, copper oxide, cuprous oxide, silicon oxide, aluminum oxide, zirconium oxide and titanium-copper oxide. The cutting particles are microparticles or nanoparticles.

The present invention features on that a surfactant that induces formation of hydrogen bonding is added for increasing the stability of the suspension. In conventional ways, polymers or polyelectrolytes are added into the cutting fluid to improve the suspension stability of the cutting particles. While adding polymers into the cutting fluid, the viscosity of the cutting fluid is significantly increased. The sedimentation velocity of the cutting particles in the cutting fluid is in inverse proportion/relation to the fluid viscosity. Thus the sedimentation velocity of the cutting particles in the cutting fluid declines with increasing viscosity. The cutting particles are suspended in the fluid for a longer time. However, the addition of polymers has limited effect on the improvement of the sediment velocity of the cutting particles. The particle precipitation still occurs and the above problems haven't been solved yet. Moreover, the increasing fluid viscosity caused by addition of polymers has great influence on the wafer fabrication processes after cutting. For example, the increased fluid viscosity leads to increasing difficulties in wafer separation or cleaning.

While adding polyelectrolytes into the cutting fluid, ions are absorbed to the cutting particles and the Coulombic interaction between the cutting particles is getting stronger. Thus the cutting particles are repelling one another, not aggregated and suspended well. Most of the cutting particles are silicon carbide particles. These particles have larger diameter and higher density so that the gravity of the cutting particles will lead to precipitation even they don't aggregate and settle. However, the effect of adding electrolytes is limited. The addition of the electrolytes will cause the cutting solution to have a large amount of charges and its effect on the stability of wafers still remains unclear.

The surfactant that induces hydrogen bonding used in the cutting solution of the present invention contains amine functional groups or acid functional groups. The amine functional group is NH2 and the acid functional group is an acetate ion while the surfactant that induces hydrogen bonding includes a carbon chain length between C6 and C18.

Hydrophilic groups of the hydrogen-bonding-inducing surfactant are capable to form intermolecular hydrogen bonding. That's hydrogen bonding force among molecules of the surfactant and the hydrogen bonding force allows the cutting particles have three-dimensional network structure, displaying gel-like behavior. Thus the suspension time of the cutting particles is significantly increased besides changing of the settling velocity of the cutting particles.

The hydrogen-bonding-inducing surfactant used in the cutting solution of the present invention not only modifies the settling velocity of the cutting particles, but also increases the suspension time of the cutting particles. Thus the suspension stability of the cutting particles is effectively improved. The difference between the hydrogen-bonding-inducing surfactant in the cutting solution of the present invention and the above additive is in that: the surfactant in the cutting fluid of the present invention will not increase viscosity of the solution and further prevent following wafer manufacturing processes after the cutting from being affected by the viscosity change. Moreover, the surfactant in the cutting solution of the present invention reduces the surface tension of the cutting fluid and this helps the cleaning process.

In summary, the present invention provides a cutting fluid used for wafer processing. The cutting fluid consists of a cutting solvent, a plurality of cutting particles and a surfactant that induces hydrogen bonding. The hydrogen-bonding- inducing surfactant contains amine functional groups or acid functional groups. The formation of intermolecular hydrogen bonding among surfactant molecules can effectively improve the suspension stability of the cutting particles in the cutting fluid. Moreover, the surfactant that induces hydrogen bonding will not change the properties of the cutting fluid so that the following manufacturing processes will not be affected.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A cutting fluid for wafer processing comprising:
at least one cutting solvent being ethylene glycol;
a plurality of cutting particles added in the cutting solvent; and
at least one surfactant being R—COOH, R=C6˜C18, that induces hydrogen bonding added into the cutting solvent; wherein a plurality of molecules of the surfactant that induces hydrogen bonding can form intermolecular hydrogen bonding to display gel-like behavior, thereby improving-suspension stability of the plurality of cutting particles in the cutting solvent.

2. (canceled)

3. (canceled)

4. (canceled)

5. The cutting fluid for wafer processing as claimed in claim 1, wherein the concentration of the surfactant that induces hydrogen bonding ranges from 0 weight percent (wt %) to 20 wt %.

6. (canceled)

7. (canceled)

8. The cutting fluid for wafer processing as claimed in claim 1, wherein the cutting particles are made from silicon carbide, copper oxide, cuprous oxide, silicon oxide, aluminum oxide, zirconium oxide and titanium-copper oxide.

9. The cutting fluid for wafer processing as claimed in claim 1, wherein the cutting particles are cutting particles are microparticles or nanoparticles.
